(19) United States
(12) Patent Application Publication
(10) Pub. No.: US 2025/0018685 A1
(43) Pub. Date: Jan. 16, 2025

(54) WINDSHIELD FOR VEHICLE

(71) Applicant: AGC Inc., Tokyo (JP)

(72) Inventors: Yuukou MINAMIYA, Tokyo (JP); Atsushi ITO, Tokyo (JP)

(73) Assignee: AGC Inc., Tokyo (JP)

(21) Appl. No.: 18/899,190

(22) Filed: Sep. 27, 2024

Related U.S. Application Data
(63) Continuation of application No. PCT/JP2023/012023, filed on Mar. 24, 2023.

(30) Foreign Application Priority Data
Mar. 30, 2022 (JP) 2022-055940

(51) Int. Cl. B32B 17/10; B60J 1/00; B60R 11/00; B60R 11/04; B60S 1/02

(52) U.S. Cl. CPC B32B 17/10036; B32B 17/10183; B32B 17/10376; B32B 17/10651; B60J 1/001; B60R 11/04; B60S 1/026; B32B 2250/40; B32B 2255/20; B32B 2307/412; B32B 2457/00; B32B 2551/00; B32B 2605/00; B32B 2605/08; B60R 2011/0026

(57) ABSTRACT

A windshield for vehicle including: a laminated glass including: a first glass plate; and a glass plate with a terminal having a second glass plate, a conductor having a terminal joint portion, and a terminal joined onto the terminal joint portion with lead-free solder interposed therebetween, in which: in the conductor, a feeding portion including a terminal joint portion is formed directly on the second glass plate; a first light-shielding layer is formed on a first glass plate, the first light-shielding layer covering a feeding portion of a conductor; and a second light-shielding layer is formed on the glass plate with the terminal, the second light-shielding layer covering at least a part of the conductor except for the feeding portion.

### INCORPORATION BY REFERENCE

This application is a Bypass Continuation of International Patent Application No. PCT/JP2023/012023, filed on Mar. 24, 2023, which claims priority based on Japanese Patent Application No. 2022-055940, filed on Mar. 30, 2022, the disclosure of which is incorporated herein in its entirety.

### BACKGROUND

The present disclosure relates to a windshield for vehicle.

A laminated glass in which a plurality of glass plates are bonded together or a tempered glass is preferably used for a window glass for a vehicle such as an automobile. Typically, a glass plate used as a material for a windshield for vehicle has a light-shielding layer formed in its peripheral region, and is processed into a shape having a curved surface by thermoforming.

Additionally, a windshield for vehicle is known that includes: a conductor that includes an electric function portion or is connected to an electric function portion; and feeding members such as a harness and a cable. Examples of the electric function portion include an electric heating wire, an electric heating layer, an antenna, a light control layer, a light emitting element, and combinations thereof.

In this description, a glass plate having a conductor is referred to as a “glass plate with a conductor.”

The light-shielding layer can be formed, for example, by coating and firing a ceramic paste containing a black pigment and glass frit. The conductor can be formed, for example, by coating and firing a silver-containing paste containing silver powder and glass frit. Firing of the ceramic paste and the silver-containing paste can be implemented simultaneously with thermoforming of the glass plate.

On the inner surface of the windshield, for the purpose of autonomous driving and preventing collision accidents and the like, an optical apparatus may be installed that include optical devices such as ADAS (advanced driver assistance systems) cameras, LiDAR (light detection and ranging), a radar, and optical sensors that acquire information in front of the vehicle, and a housing called a bracket etc. that houses these. In such a configuration, an electric heating wire may be formed on the glass portion in front of the optical devices to prevent fogging and frost, in order to improve the sensing accuracy by the optical apparatus.

The glass plate with the conductor on which the optical apparatus is mounted can have, in a plan view, an optical apparatus mounting region where the optical apparatuses are mounted; and a light-transmitting portion, located within the optical apparatus mounting region, through which light incident on the optical apparatuses from the outside and/or light emitted from the optical apparatuses passes, and a light-shielding layer surrounding at least a part of the light-transmitting portion.

The conductor for the optical apparatus can include: an electric heating wire formed inside the light-transmitting portion; a feeding portion including a pair of feeding electrodes (also called busbars) etc. formed outside the light-transmitting portion; a connection wire formed outside the light-transmitting portion and connecting the electric heating wire and the feeding portion. Feeding member such as a harness and a cable is joined to each feeding electrode.

In the conductor for the optical apparatus, the electric heating wire formed in the light-transmitting portion is designed to be thin so as to be unlikely to be visible to people outside the vehicle and so as not to affect the acquisition of information about the area in front of the vehicle by the optical apparatus through the light-transmitting portion. Contrarily, the feeding portion is not intended to generate heat and needs an area in which the feeding member is joined thereto, is therefore designed to be thicker than the electric heating wire. For this reason, conventionally, the feeding portion is typically formed on a light-shielding layer so that the feeding portion is not visible to people outside the vehicle.

Conventionally, a feeding portion and feeding member are joined using solder.

For example, a terminal is fixed to the head end portion of feeding member such as a wire harness, and this terminal is joined to the feeding portion included in the conductor using solder. There are two types of solder: leaded solder and lead-free solder. In recent years, concerns about impacts of lead on the environment have arisen and legal restrictions on leaded solder have been more widespread, making it desirable to use lead-free solder.

Typically, the melting point of lead-free solder is higher than that of leaded solder, and is, for example, about 220° C., so it is necessary to implement solder joining at a higher temperature (for example, about 300° C.). In the glass plate with the conductor, when the conductor and terminals are joined with lead-free solder, the glass plate is locally heated to high temperatures and cooled from the high temperature to normal temperature. When the temperature drops, a difference in thermal expansion coefficient between the glass plate and the lead-free solder causes a difference in the amount of thermal contraction between the glass plate and the lead-free solder, and causes strain between the glass plate and the lead-free solder, causing stress (specifically, tensile stress) to be generated in the glass plate with the conductor. The stress may remain also after the temperature drop. This residual stress may cause cracks to occur in the glass plate after manufacturing of the window glass. In addition, since lead-free solder does not contain lead, which has a low elastic modulus, lead-free solder has a higher elastic modulus and is more unlikely to deform than leaded solder. This causes the residual stress generated in the glass plate with the conductor to be unlikely to alleviate. For these reasons, when the conductor and the terminal are joined with lead-free solder, residual stress may occur in the glass plate after joining, which may disadvantageously result in cracks occurring after manufacturing.

In this description, a glass plate having a conductor and a terminal is referred to as a “glass plate with a terminal.”

If the breaking strength of the glass plate after terminal attachment is low, glass cracking may occur when external force is applied to the glass plate. In particular, when a terminal is joined to a feeding portion formed on a light-shielding layer using lead-free solder, the breaking strength of the glass plate after terminal attachment tends to decrease. It is preferable that the conductor be designed so that it is unlikely to be visible to people outside the vehicle while the breaking strength of the glass plate after terminal attachment can be increased in solder joining using lead-free solder.

In this description, “breaking strength of a glass plate before or after terminal attachment” is the load at the time of breakage when a load is applied to the glass before or after terminal attachment, and can be measured through the method described in [Example] section below.

Examples of the related art to the present disclosure includes International Patent Publication No. WO 2010/150832, Japanese Unexamined Patent Application Publication No. 2008-044800, and International Patent Publication No. WO 2011/138600.

International Patent Publication No. WO 2010/150832 discloses, in claim 1, a window glass with a conductive ceramic sintered body,
the window glass having a visible region, and a light-shielding region consisting of a strip region and a dot pattern region,
the window glass including linear portions and a feeding point on either of main surfaces of at least one of glass plates configuring the window glass, the linear portions and the feeding point both being made of a conductive ceramic sintered body, in which
the conductive ceramic sintered body contains silver and glass components,
the linear portions are formed in the visible region, the strip region, and the dot pattern region,
the linear portion formed in the dot pattern region has a colored layer laminated on at least a part of the linear portion,
the linear portion formed in the strip region has a colored layer laminated on the entire surface of the linear portion, and
the colored layers form at least a part of the strip region and the dot pattern region.

In International Patent Publication No. WO 2010/150832, the coloring is black, gray, or the like (paragraph 0004), and the colored layers form at least a part of a light-shielding region consisting of a strip region and a dot pattern region.

International Patent Publication No. WO 2010/150832 discloses a configuration in which a light-shielding layer is laminated on at least a part of linear conductors (linear portions) containing silver and glass components.

However, International Patent Publication No. WO 2010/150832 describes that it is preferable that a feeding point (6) be laminated on a feeding point colored layer (4C) (Claim 2, FIGS. 2 and 3, etc.). Here, the feeding point (6) corresponds to the feeding portion, and the feeding point colored layer (4C) corresponds to the light-shielding layer.

International Patent Publication No. WO 2010/150832 does not describe or suggest any problem with joining a terminal using lead-free solder or any means for solving the problem. In the technique described in International Patent Publication No. WO 2010/150832 in which a feeding portion is formed on a light-shielding layer, when the terminal is joined using lead-free solder, the breaking strength of the glass plate decreases after terminal attachment.

Japanese Unexamined Patent Application Publication No. 2008-044800 discloses, in claim 1, a window glass with a conductive ceramic sintered body including: a glass plate; and a conductive ceramic sintered body that contains silver and glass components and is formed on at least one main surface of the glass plate, in which the conductive ceramic sintered body contains a pigment on its surface other than a feeding point.

The pigment can contain at least one of copper oxide and chromium oxide, in which case the conductive ceramic sintered body can be blackened (claim 4, paragraph 0024).

Japanese Unexamined Patent Application Publication No. 2008-044800 discloses a configuration in which a conductor containing silver and glass components is formed directly on a glass plate, and a light-shielding layer is laminated on the surface of the conductor other than the feeding point.

However, Japanese Unexamined Patent Application Publication No. 2008-044800 does not disclose any means for hiding the feeding point.

In addition, Japanese Unexamined Patent Application Publication No. 2008-044800 does not describe or suggest any problem with joining a terminal using lead-free solder or means for solving the problem.

International Patent Publication No. WO 2011/138600 relates to a method for soldering conductors formed on a thin glass sheet. The literature discloses that: printing a conductor (6) directly onto a sheet (1) facilitates more reliable solder connection (7) of a second conductor (8) to the conductor (6); and the conductor (7) can be, for example, a heating element or a busbar in the wiper rest area, and is hidden from the view of people outside the vehicle thanks to a layer (5) (see FIG. 2 and the description thereof). In addition, the section “Examples” also describes the effect of preventing cracking after solder joining when the conductor (6) is printed directly onto the sheet (1).

However, International Patent Publication No. WO 2011/138600 does not disclose any aspect in which at least a part of the conductor printed directly onto the sheet is covered with a light-shielding layer.

The present disclosure has been made in view of the above circumstances, and it is an object thereof to provide a windshield for vehicle that includes a portion in which a conductor and a terminal are joined using lead-free solder, can be designed so that a feeding portion of the conductor is not visible to people outside the vehicle, and can increase breaking strength of a glass plate after terminal attachment.

### SUMMARY

The present disclosure provides a windshield for vehicle of the following [1] to [11].

[1] A windshield for vehicle including a laminated glass in which a first glass plate and a second glass plate are bonded together with an intermediate film interposed therebetween,
the laminated glass including a glass plate with a terminal, the glass plate with the terminal including the second glass plate, a conductor, and the terminal, the conductor being formed on a surface of the second glass plate, the surface being on an opposite side of the intermediate film, the conductor including a material containing silver and glass frit, the conductor having a terminal joint portion to which the terminal is joined, the terminal being joined onto the terminal joint portion of the conductor with lead-free solder interposed therebetween, in which
the conductor includes an electric function portion or is electrically connected to an electric function portion,
the conductor includes a feeding portion for feeding electricity to the electric function portion, and the feeding portion includes the terminal joint portion,
in the conductor, at least the feeding portion is formed directly on the second glass plate,
a first light-shielding layer is formed on a surface of the first glass plate, the first light-shielding layer covering the feeding portion of the conductor in a plan view, the surface being on a side of the intermediate film, and
a second light-shielding layer is formed on a surface of the glass plate with the terminal, the second light-shielding layer covering at least a part of the conductor except for the feeding portion in a plan view, the surface being on an opposite side of the intermediate film.

[2] The windshield for vehicle of [1], in which
in a plan view, the glass plate with the terminal includes: an optical apparatus mounting region where an optical apparatus is mounted; and a light-transmitting portion, located within the optical apparatus mounting region, through which light incident on the optical apparatus from an outside and/or light emitted from the optical apparatus passes,
the second light-shielding layer is formed so as to surround at least a part of the light-transmitting portion in a plan view, and
the conductor includes an electric heating wire formed inside the light-transmitting portion, the feeding portion formed outside the light-transmitting portion, and a connection wire formed outside the light-transmitting portion and connecting the electric heating wire and the feeding portion.

[3] The windshield for vehicle of [2], in which
in the glass plate with the terminal, the electric heating wire, the connection wire, and the feeding portion are formed directly on the second glass plate, and
in a plan view, the feeding portion is not covered by the second light-shielding layer, and at least a part of the connection wire is covered by the second light-shielding layer.

[4] The windshield for vehicle of [2] or [3], in which the electric heating wire and the connection wire each have a line width of 0.1 to 1.0 mm.

[5] The windshield for vehicle of any of [2] to [4], in which a line width of the electric heating wire and a line width of the connection wire are substantially the same.

[6] The windshield for vehicle of any of [2] to [5], in which in the glass plate with the terminal, an outer periphery of the optical apparatus mounting region passes between the light-transmitting portion and the feeding portion in a plan view.

[7] The windshield for vehicle of any of [2] to [6], in which
the optical apparatus includes an optical device and a housing that houses the optical device, and
the housing of the optical apparatus is fixed on the second light-shielding layer.

[8] The windshield for vehicle of [7], in which the housing of the optical apparatus is fixed onto the second light-shielding layer with one or more materials including an adhesive interposed therebetween.

[9] The windshield for vehicle of [8], in which the adhesive is at least one adhesive selected from a group consisting of an epoxy adhesive, a urethane adhesive, a silicone adhesive, a modified silicone adhesive, a melamine adhesive, a phenol adhesive, and an acrylic adhesive.

[10] The windshield for vehicle of any of [2] to [9], in which the second light-shielding layer contains a black pigment and glass frit.

[11] The windshield for vehicle of any of [1] to [10], in which a feeding member including a round-wire-shaped or foil-shaped conducting wire is fixed to the terminal.

The windshield for vehicle of the present disclosure has the conductor included in the glass plate with the terminal, in which at least the feeding portion is not formed on the light-shielding layer but is formed directly on the glass plate. This can reduce the amount of components of the glass frit on the surface of the terminal joint portion of the conductor, and can increase the breaking strength of the glass plate after terminal attachment.

The windshield for vehicle of the present disclosure has a glass plate, facing the glass plate with the terminal, on which the first light-shielding layer is formed that covers, in a plan view, a feeding portion of the conductor formed on the glass plate with the terminal. In addition, the windshield for vehicle has the glass plate with the terminal, on which a light-shielding layer is formed that covers, in a plan view, at least a part of the conductor, except for the feeding portion, formed on the glass plate with the terminal. Therefore, the feeding portion of the conductor can be designed so as not to be visible to people outside the vehicle.

The above and other objects, features and advantages of the present disclosure will become more fully understood from the detailed description given hereinbelow and the accompanying drawings.

### BRIEF DESCRIPTION OF DRAWINGS

FIG. 1A is an overall plan view of a windshield for vehicle according to an embodiment of the present invention;

FIG. 1B is an overall plan view of a first glass plate;

FIG. 2 is a partially enlarged plan view of FIG. 1A;

FIG. 3 is a partially enlarged plan view of FIG. 1A;

FIG. 4 is a partially enlarged plan view of FIG. 1A;

FIG. 5 is a cross-sectional view taken along a line V-V of FIG. 2;

FIG. 6 is a cross-sectional view taken along a line VI-VI of FIG. 2;

FIG. 7 is a cross-sectional view taken along a line VII-VII of FIG. 2;

FIG. 8 is a partially enlarged cross-sectional view of FIG. 7;

FIG. 9A is a process diagram of a method for manufacturing the windshield for vehicle according to the embodiment;

FIG. 9B is a process diagram of the method for manufacturing the windshield for vehicle according to the embodiment;

FIG. 9C is a process diagram of the method for manufacturing the windshield for vehicle according to the embodiment;

FIG. 10 is a graph showing evaluation results of Example 1;

FIG. 11 is a graph showing evaluation results of Example 2;

FIG. 12 is a graph showing evaluation results of Example 3;

FIG. 13 is a graph showing evaluation results of Example 4;

FIG. 14 is a graph showing evaluation results of Example 5; and

FIG. 15 is a graph showing evaluation results of Example 6.

### DESCRIPTION OF EMBODIMENTS

Generally, thin film structures are referred to as “films”, “sheets”, etc. depending on the thickness. In this description, these are not clearly distinguished. Therefore, the term “film” as used herein may include “sheet”.

In this description, “substantially” added to a shape means a partially changed shape, such as a chamfered shape with rounded corners, a shape with a part of the shape missing, or a shape with a small shape added to the shape.

In this description, unless otherwise specified, “glass plate” refers to un-tempered glass.

In this description, unless otherwise specified, a “surface of a glass plate” refers to the main surface with a large area, excluding the sides (also referred to as side surfaces) of the glass plate.

In this description, unless otherwise specified, “up and down”, “left and right”, “vertical and horizontal”, and “inside and outside” means “up and down”, “left and right”, “vertical and horizontal”, and “inside and outside” seen from the vehicle inner side with the windshield for vehicle being fitted into a vehicle (actual usage condition).

In this description, unless otherwise specified, the symbol “-” (or “to”) indicating a numerical range is used to mean that the numerical values written before and after the symbol are included as the lower limit and upper limit.

An embodiment of the present invention will be described below.

### [Windshield for Vehicle]

The present disclosure relates to a windshield for vehicle including a laminated glass in which a first glass plate and a second glass plate are bonded together with an intermediate film interposed therebetween.

The first glass plate can be a glass plate on the vehicle outer side, and the second glass plate can be a glass plate on the vehicle inner side.

The type of the glass plate that is a material of the laminated glass is not particularly limited, and examples thereof include soda lime glass, borosilicate glass, aluminosilicate glass, lithium silicate glass, quartz glass, sapphire glass, and alkali-free glass.

The thickness of the laminated glass is not particularly limited, and is preferably 2 to 6 mm for use as a windshield for vehicle.

The thickness of the glass plate on the vehicle inner side and the thickness of the glass plate on the vehicle outer side may be the same or different. The thickness of the glass plate on the vehicle inner side is preferably 0.3 to 2.3 mm. When the thickness of the glass plate on the vehicle inner side is 0.3 mm or more, handling properties are good, and when the thickness is 2.3 mm or less, the mass is not too large. The thickness of the glass plate on the vehicle outer side is preferably 1.0 to 3.0 mm. When the thickness of the glass plate on vehicle outer side is 1.0 mm or more, the strength such as tolerance to stone chips is sufficient, and when the thickness is 3.0 mm or less, the mass of the laminated glass is not too large, which is preferable in terms of vehicle fuel efficiency. It is preferable that the thickness of the glass plate on the vehicle outer side and the thickness of the glass plate on the vehicle inner side be both 1.8 mm or less so that both the weight reduction and sound insulation properties of the laminated glass can be achieved.

The windshield for vehicle may have a curved shape such that the windshield is convex to the vehicle outer side when the windshield is attached to the vehicle. When the windshield for vehicle is a laminated glass, the glass plate on the vehicle inner side and the glass plate on the vehicle outer side may both have a curved shape such that they are convex to the vehicle outer side. The windshield for vehicle may have a single curved shape that is curved in only one direction, either the left-right direction or the up-down direction, or the windshield may have a multi-curved shape that is curved in the left-right direction and the up-down direction. The curvature radius of the windshield for vehicle may be between 2000 and 11000 mm. The windshield for vehicle may have the curvature radius in the left-right direction and that in the up-down direction that are identical or non-identical. Gravity forming, press forming, roller forming, etc. are used for bending and forming the windshield for vehicle.

The laminated glass may have a coating having functions such as water repellency, low reflectivity, low radioactivity, ultraviolet shielding, infrared shielding, and coloring on at least a part of region of the surface.

The laminated glass may have a film having functions such as low reflectivity, low radioactivity, ultraviolet shielding, infrared shielding, and coloring in at least a part of region of the inside. At least a part of region of the intermediate film of the laminated glass may have functions such as ultraviolet shielding, infrared shielding, and coloring.

The intermediate film of laminated glass may be a single layer film or a laminated film.

In the windshield for vehicle of the present disclosure, the laminated glass includes a glass plate with a terminal, the glass plate with the terminal including the second glass plate, a conductor, and the terminal, the conductor being formed on a surface of the second glass plate, the surface being on the opposite side of the intermediate film, the conductor including a material containing silver and glass frit, the conductor having a terminal joint portion to which the terminal is joined, the terminal being joined onto the terminal joint portion of the conductor with lead-free solder interposed therebetween,

In this description, the “terminal joint portion” of the conductor refers to a portion of the conductor immediately underneath the lead-free solder.

In the glass plate with the terminal, the above-described conductor includes an electric function portion or is electrically connected to an electric function portion.

Examples of the electric function portion include one or more electric heating wires, an electric heating layer, an antenna, a light control layer, a light emitting element, and a combination thereof. Examples of the light emitting element include an LED (light emitting diode) and an OLED (organic light emitting diode).

The one or more electric heating wires or an electric heating layer make it possible to remove fog, frost, snow, ice, etc. and prevent them from adhering. The one or more electric heating wires or an electric heating layer can be used, for example, to prevent wipers from freezing, and to improve sensing accuracy by optical apparatuses including optical devices such as cameras and radars.

The electric function portion can be manufactured by a known method.

In the glass plate with the terminal, the above-described electrical conductor includes a feeding portion for feeding electricity to the electric function portion. The feeding portion can include a pair of feeding electrodes (also referred to as a pair of busbars), and each feeding electrode can include a terminal joint portion.

For example, one feeding electrode is a positive electrode and is connected to a power source or a signal source provided in the vehicle with the feeding member interposed therebetween, and the other feeding electrode is a negative electrode and is connected to the vehicle body (ground) with the feeding member interposed therebetween. Note that the feeding electrode for the positive electrode may be single or plural, and the feeding electrode for the negative electrode may be single or plural.

When the conductor is connected to an electric function portion, the conductor and the electric function portion may be formed on the same glass surface or on different glass surfaces.

The conductor having a terminal joint portion is formed through a method for applying a silver-containing paste containing silver powder and glass frit onto a glass plate and firing the paste.

A feeding member including a round-wire-shaped or foil-shaped conducting wire can be fixed to the terminal. The term “conducting wire” as used herein includes a covered conducting wire in which one or more conducting wires are covered with an insulating material. As the feeding member, a covered conducting wire is preferable.

Examples of the specific form of the feeding member include a harness and a cable. Examples of the round-wire-shaped conducting wire include a wire harness. Examples of the foil-shaped conducting wire include a flat harness and a flexible printed circuit board.

The feeding member has a conductor-exposed portion, and a terminal is fixed to this conductor-exposed portion. The material of the conductor-exposed portion is not particularly limited, and examples thereof include Cu, Al, Ag, Au, Ti, Sn, Zn, alloys thereof, and combinations thereof. The conductor-exposed portion may be formed by plating the surface of the main metal with another metal. The conductor-exposed portion may have a thin oxide film on the surface.

Lead-free solder is solder that contains little or no lead, and any known solder can be used. The lead content in the lead-free solder is 500 ppm or less. Examples of lead-free solder include: SnAg-based solder containing Sn and Ag; SnAgCu-based solder containing Sn, Ag, and Cu; SnZnBi-based solder containing Sn, Zn, and Bi; SnCu-based solder containing Sn and Cu; SnAgInBi-based solder containing Sn, Ag, In, and Bi; and SnZnAl-based solder containing Sn, Zn, and Al.

From the viewpoint of environmental resistance and the like, lead-free solders such as SnAg-based and SnAgCu-based solders are preferred.

The melting point of lead-free solder such as SnAg-based and SnAgCu-based solder is higher than that of leaded solder, and is for example, about 220° C. In using lead-free solder such as SnAg-based and SnAgCu-based solder, the solder joint temperature is, for example, about 300° C. The present disclosure is particularly effective in using lead-free solders such as SnAg-based and SnAgCu-based solders having high melting points.

Examples of the composition of SnAg-based lead-free solder include Sn: 98% by mass, and Ag: 2% by mass. Examples of the composition of SnAgCu-based lead-free solder include Sn: 96.5% by mass, Ag: 3.0% by mass, and Cu: 0.5% by mass.

The feeding portion of the conductor included in the glass plate with the terminal is designed to be thicker than the electric heating wire and a connection wire, and is therefore preferably designed so as not to be visible to people outside the vehicle.

In the conductor for the above optical apparatus, the electric heating wire formed in the light-transmitting portion is designed to be thin so as to be unlikely to be visible to people outside the vehicle and so as not to affect the acquisition of information about the area in front of the vehicle by the optical apparatus through the light-transmitting portion. Other elements (specifically, the feeding portion and the connection wire) are typically formed on the light-shielding layer. However, in particular, when a terminal is joined to a feeding portion formed on a light-shielding layer using lead-free solder, the breaking strength of the glass plate after terminal attachment tends to decrease.

In addition, the study conducted by the present inventors has found that a conductor containing silver and glass frit has a large amount of components of the glass frit present on the surface of the conductor. In particular, it has been found that when a conductor is formed on a light-shielding layer, more components of the glass frit are present on the surface of the conductor. It is presumed that these facts are caused in such a way that when the conductor-forming material and the light-shielding layer-forming material are fired, some of the components of the glass frit contained in these materials migrate to the surface side.

In general, the wettability of lead-free solder to components of the glass frit is low. It is thought that: when a large amount of components of the glass frit is present on the surface of the conductor, the joining strength of the lead-free solder to the conductor decreases, so that it is difficult to form a well-shaped solder fillet, decreasing the breaking strength of the glass plate after terminal attachment.

In the present disclosure, at least the feeding portion is formed directly on the second glass plate in the conductor included in the glass plate with the terminal. In other words, in the conductor included in the glass plate with the terminal, at least the feeding portion is formed on the surface of the second glass plate so as to be in contact with the second glass plate without a light-shielding layer interposed therebetween. In the conductor included in the glass plate with the terminal, the feeding portion is not covered with a light-shielding layer because the terminal is joined onto the feeding portion.

In such a configuration, the feeding portion does not have components of the glass frit thereon that are derived from the material for forming the light-shielding layer. This can reduce the amount of components of the glass frit present on the surface of the feeding portion formed on the light-shielding layer. It is thought that this will make it possible to improve the wettability of the lead-free solder for the feeding portion, improve the joining strength of the lead-free solder for the feeding portion, and form well-shaped solder fillets. According to the present disclosure, combination of the above effects allows increase in the breaking strength of the glass plate after terminal attachment.

In present disclosure, the first light-shielding layer is formed on a surface of the first glass plate, the first light-shielding layer covering, in a plan view, the feeding portion of the conductor included in the glass plate with the terminal, the surface being on the intermediate film side (in other words, the surface of the first glass plate being on the side facing the second glass plate). In addition, the second light-shielding layer is formed on a surface of the glass plate with the terminal, the second light-shielding layer covering at least a part of the conductor except for the feeding portion in a plan view, the surface being on the opposite side of the intermediate film (in other words, the surface being on the side on which the conductor of the glass plate with the terminal is formed). With this configuration, at least a part of the conductor included in the glass plate with the terminal, preferably most of the conductor included in the glass plate with the terminal, can be designed so as not to be visible to people outside the vehicle.

The light-shielding layer can be formed by a known method, for example, by applying a ceramic paste containing a black pigment and glass frit to a predetermined region on the surface of a glass plate, and firing the ceramic paste. The thickness of the light-shielding layer is not particularly limited, and is, for example, 5 to 20 μm.

As the glass frit for the conductor and the light-shielding layer, any known one can be used. As the metal element, those containing Na, Al, Si, P, Zn, Ba, Bi, etc. can be used.

The glass plate with the terminal on which the optical apparatus is mounted includes, in a plan view, an optical apparatus mounting region where the optical apparatuses are mounted; and a light-transmitting portion, located within the optical apparatus mounting region, through which light incident on the optical apparatuses from the outside and/or light emitted from the optical apparatuses passes.

In the glass plate with the terminal, the second light-shielding layer is formed so as to surround at least a part of the light-transmitting portion in a plan view, and the conductor can include the electric heating wire formed inside the light-transmitting portion, the feeding portion formed outside the light-transmitting portion, and the connection wire formed outside the light-transmitting portion and connecting the electric heating wire and the feeding portion.

In the glass plate with the terminal, the electric heating wire, the connection wire, and the feeding portion can be formed directly on the second glass plate.

It is possible that, in a plan view, the feeding portion is not covered by the second light-shielding layer and at least a part of the connection wire is covered by the second light-shielding layer.

The housing of the optical apparatus can be attached to the glass plate with the terminal using one or more materials including an adhesive, preferably a combination of an adhesive and a double-sided tape. As the adhesive, a urethane adhesive or the like is preferred from the viewpoints of stability, flexibility, and the like.

If the silver-containing conductor is in contact with or are in close proximity to the adhesive, and if condensation occurs while silver-containing conductor is energized, for example, ion migration may occur between the silver element contained in the conductor and the metal elements contained in the adhesive (for example, sulfur element in the case of a urethane adhesive). This may create a defect in the electric heating circuit formed by the conductor.

Therefore, in the conventional technique in which the connection wire and the feeding portion are formed on the light-shielding layer, the housing of the optical apparatus is bonded, in a plan view, with a sufficient gap from the conductor for the optical apparatus, at a position outside the conductor including: the electric heating wire formed inside the light transmitting portion; the feeding portion formed outside the light-transmitting portion; and the connection wire connecting the electric heating wire and the feeding portion. In this case, it is necessary to design the shape and size of the housing so as to take a sufficient gap from the conductor for the optical apparatus at a position outside the conductor, making it difficult to reduce the size of the housing.

In the present disclosure, in the glass plate with the terminal on which the optical apparatus is attached, the feeding portion is not covered by the second light-shielding layer formed on the glass plate with the terminal, and at least a part of the connection wire is covered by the second light-shielding layer formed on the glass plate with the terminal. In the connection wire, the conductor is not exposed in the part covered with the second light-shielding layer, so that ion migration does not occur between the conductor and the adhesive. Therefore, even in a region where the connection wire is present, the housing of the optical apparatus can be fixed as long as the connection wire is covered with the second light-shielding layer. In this case, the housing of the optical apparatus can be fixed onto the second light-shielding layer around the light-transmitting portion with one or more materials including an adhesive interposed therebetween. In other words, in the present disclosure, the glass plate with the terminal, on which the optical apparatus is attached, has the adhesive region of the housing of the optical apparatus including at least a part of the formation region of the connection wire, allowing the adhesive region to be covered with the second light-shielding layer.

In the present disclosure, the shape and size of the housing can be freely designed if the housing avoids the regions of the light-transmitting portion and the feeding portion, allowing the housing to be also made compact. Furthermore, since the surface of a silver-containing conductor is likely to be damaged in general, the surface of the connection wire may be damaged and broken, for example, when the housing of the optical apparatus is attached. Covering at least a part of the connection wire with the second light-shielding layer allows the connection wire to be prevented from being damaged in attaching the housing of the optical apparatus or the like.

In the present disclosure, the glass plate with the terminal can be designed so that the outer periphery of the optical apparatus mounting region passes, in a plan view, between the light-transmitting portion and the feeding portion, for example.

In conventional technique for forming connection wire and a feeding portion on a light-shielding layer, from the viewpoint of preventing ion migration between the silver-containing conductor and the adhesive, the separation distance between the housing of the optical apparatus and the conductor is, in a plan view, preferably 8 mm or more, more preferably 10 mm or more, and particularly preferably 14 mm or more.

In contrast, in the present disclosure, the separation distance between the housing of the optical apparatus and the conductor is not particularly limited, and may be 20 mm or less, 14 mm or less, 10 mm or less, 8 mm or less, 7 mm or less, or 5 mm or less, in a plan view. The housing of the optical apparatus and the conductor may overlap in a plan view.

### EMBODIMENT

The present disclosure can be preferably applied to a windshield for vehicle to which an optical apparatus is attached.

The structure of a windshield for vehicle according to an embodiment of the present invention will be described with reference to the drawings.

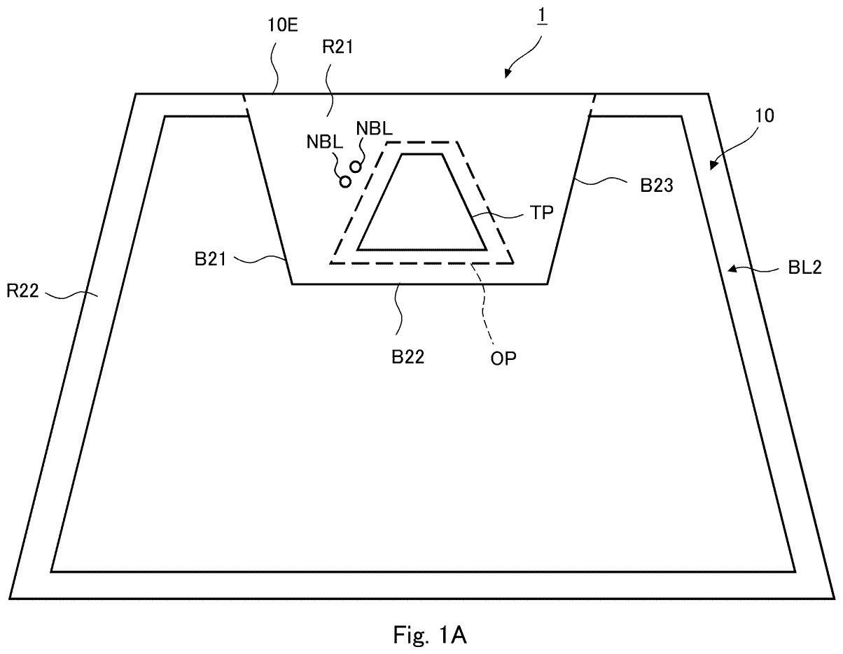

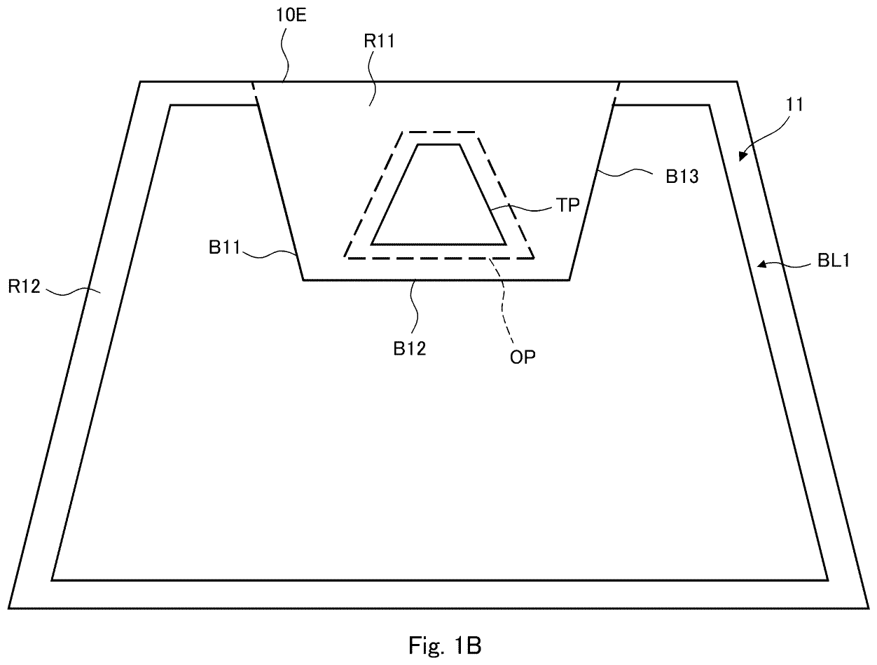

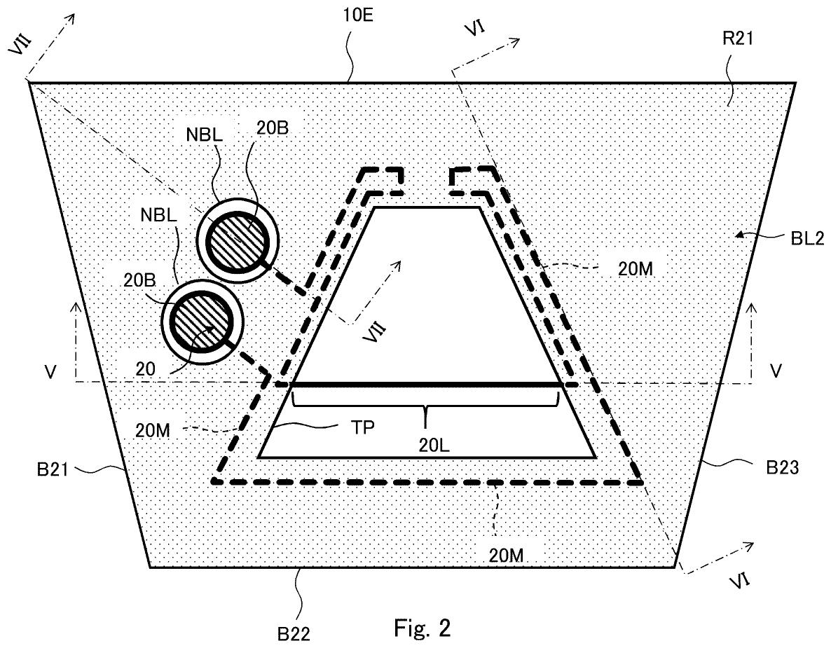

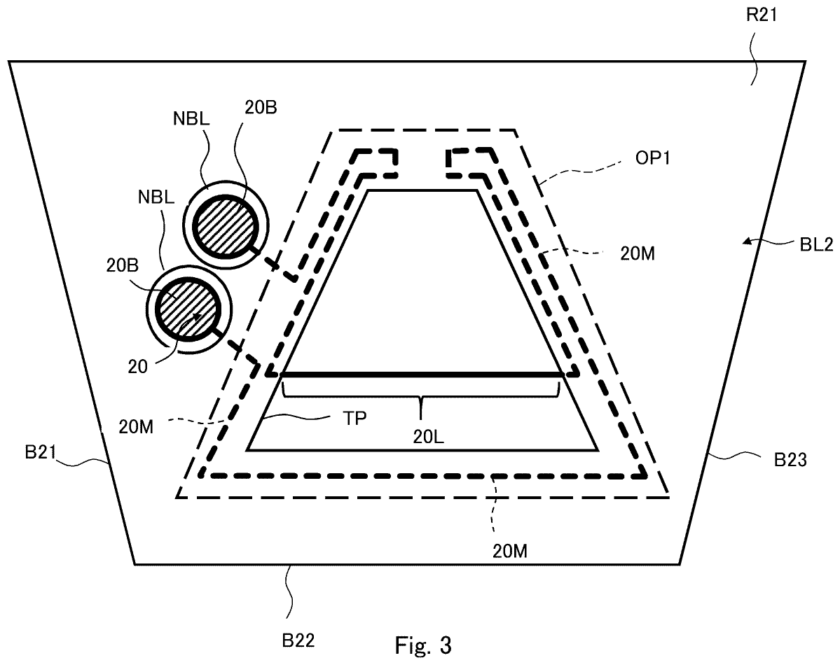

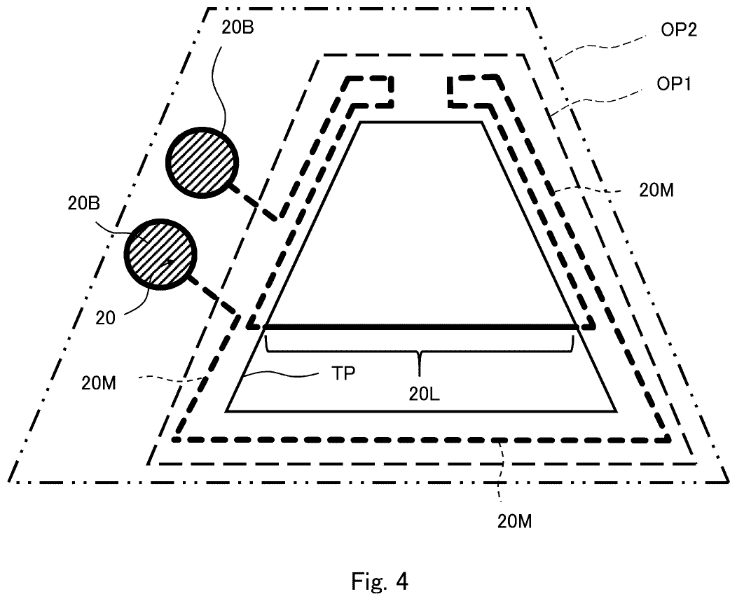

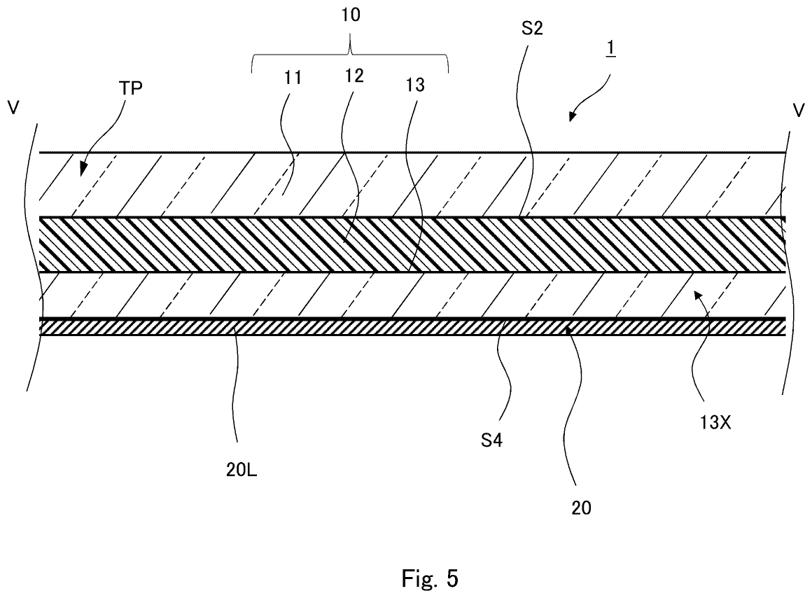

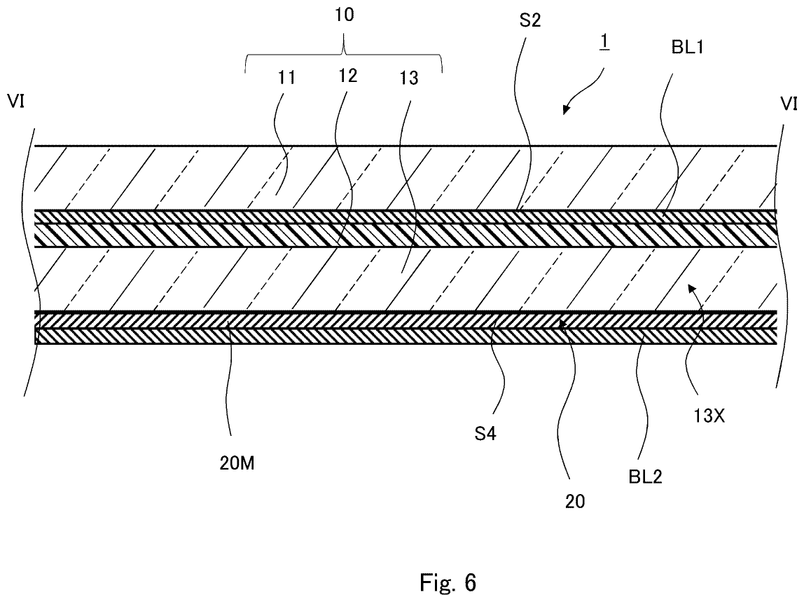

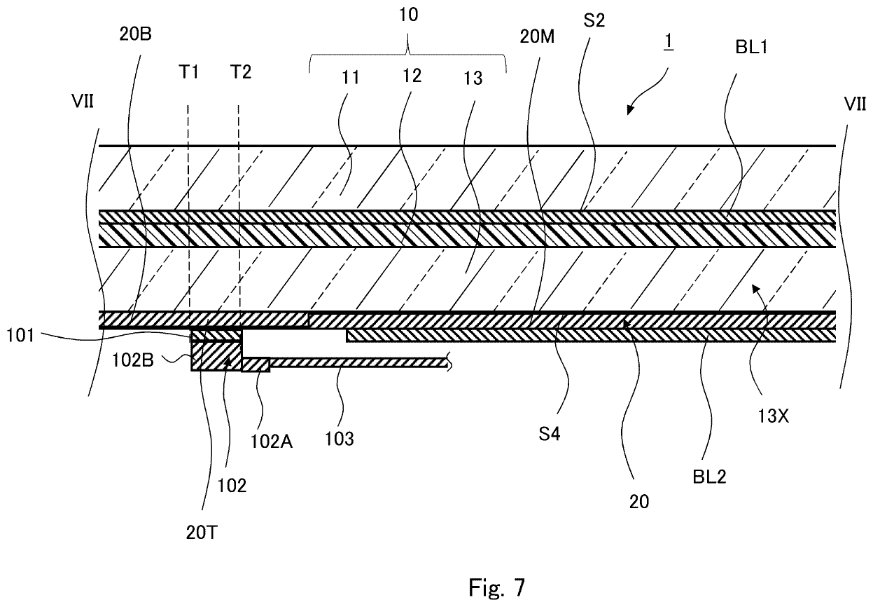

FIG. 1A is an overall plan view of the windshield for vehicle of this embodiment. FIG. 1B is an overall plan view of the first glass plate. FIG. 2 to 4 are partially enlarged plan views of FIG. 1A. FIG. 2 to 4 are partially enlarged plan views of the same region. In FIG. 2, the second light-shielding layer is indicated by dot hatching, and in FIGS. 3 and 4, the dot hatching of the second light-shielding layer is omitted and a design example of the optical apparatus mounting region OP is shown. FIGS. 1A, and 2 to 4 are diagrams before joining a terminal. In FIGS. 1A, 1B and 2 to 4, the front side of the figures is the vehicle inner side, and the back side of the figures is the vehicle outer side. FIG. 5 is a cross-sectional view taken along a line V-V of FIG. 2. FIG. 6 is a cross-sectional view taken along a line VI-VI of FIG. 2. FIG. 7 is a cross-sectional view taken along a line VII-VII of FIG. 2. In FIG. 5 to 7, the upper side of the figure is the vehicle outer side, and the lower side of the figure is the vehicle inner side. All of these figures are schematic diagrams, and for ease of visual recognition, the scale of each component is made different from the actual one as appropriate in each drawing.

The planar shape of the windshield for vehicle 1 can be appropriately designed, and the examples thereof include a shape in which a substantially trapezoidal plate in a plan view is curved as a whole, as shown in FIG. 1A.

As shown in FIG. 7, the windshield for vehicle 1 of this embodiment includes a laminated glass 10 in which a first glass plate 11 and a second glass plate 13 are bonded together with an intermediate film 12 interposed therebetween.

In this embodiment, the laminated glass 10 includes a glass plate with terminals 13X including a second glass plate 13, a conductor 20, and terminals 102, the conductor 20 being formed on a surface S4 of the second glass plate 13, the surface S4 being on the opposite side of the intermediate film 12 (the surface S4 being on the vehicle inner side), the conductor 20 being made of a material containing silver and glass frit, the conductor 20 having terminal joint portions 20T to each of which a terminal 102 is joined, the terminals 102 each being joined onto a terminal joint portion 20T of the conductor 20 with lead-free solder 101 interposed therebetween.

In the illustrated example, the laminated glass 10 is a laminated glass in which a first glass plate 11 and a glass plate with terminals 13X are bonded together with an intermediate film 12 interposed therebetween.

In this embodiment, the first glass plate 11 is the glass on the vehicle outer side, and the glass plate with terminals 13X is the glass on the vehicle inner side.

As shown in FIG. 1A, the windshield for vehicle 1 includes: an optical apparatus mounting region OP where an optical apparatus is mounted; and a light-transmitting portion TP located within the optical apparatus mounting region OP, through which light incident on the optical apparatuses from the outside and/or light emitted from the optical apparatuses passes.

As illustrated, the light-transmitting portion TP can be formed in a region relatively close to one end side 10E of the windshield for vehicle 1 (in the illustrated example, the upper end side).

For autonomous driving and prevention of collision accidents, etc., for example, the optical apparatus can include: optical devices such as ADAS (advanced driver assistance systems) cameras, LiDAR (light detection and ranging), a radar, and optical sensors that acquire information in front of the vehicle; and a housing called a bracket etc. that houses these.

The shape of the optical apparatus mounting region OP and the light-transmitting portion TP can be appropriately designed depending on the shape of the optical apparatus, and the examples thereof include a substantially trapezoidal shape and a substantially rectangular shape. The shapes of the optical apparatus mounting region OP and the light-transmitting portion TP may be similar or dissimilar. In the illustrated example, the optical apparatus mounting region OP and the light-transmitting portion TP have a substantially trapezoidal shape.

As shown in FIG. 7, a first light-shielding layer BL1 is formed in a predetermined region of a surface S2 of the first glass plate 11, the surface S2 being on the intermediate film 12 side (the surface S2 being on the vehicle inner side, the surface S2 facing the second glass plate 13). Also as shown in the figure, a second light-shielding layer BL2 is formed in a predetermined region on the surface S4 of the second glass plate 13, the surface S4 being on the opposite side of the intermediate film 12 (the surface S4 being on the vehicle inner side).

As shown in FIG. 1A, the formation region of the second light-shielding layer BL2 can include: a region of the optical apparatus mounting region OP, excluding the light-transmitting portion TP; a region around the optical apparatus mounting region OP; and a peripheral region of the windshield for vehicle 1.

In the illustrated example, the formation region of the second light-shielding layer BL2 includes: the region of the optical apparatus mounting region OP excluding the light-transmitting portion TP; and the region around the optical apparatus mounting region OP, and includes: a region R21 of a substantially trapezoidal region, the outline of which is formed of one end side 10E of the laminated glass 10 (in the illustrated example, the upper end side) and sides B21 to B23, excluding the light-transmitting portion TP; and a peripheral region R22 of the windshield for vehicle 1. As will be described later in detail, the region R21 partially includes non-formation regions NBL of the second light-shielding layer BL2.

In the illustrated example, the second light-shielding layer BL2 surrounds all four sides of the light-transmitting portion TP. However, the second light-shielding layer BL2 just needs to surround at least a part of the light-transmitting portion TP, and, for example, may surround only three sides of the substantially trapezoidal or substantially rectangular light-transmitting portion TP.

The wavelength range of light transmitted by the light-transmitting portion TP is not particularly limited, and includes, for example, the visible light range, the infrared light range, and the visible light range to infrared light range.

As shown in FIG. 2, in this embodiment, the conductor 20 includes an electric function portion including an electric heating wire 20L formed inside the light-transmitting portion TP. The conductor 20 further includes a feeding portion including a pair of feeding electrodes (a pair of busbars) 20B formed outside the light-transmitting portion TP. The conductor 20 further includes two connection wires 20M that are formed outside the light-transmitting portion TP and connect the electric heating wire 20L and a pair of feeding electrodes (a pair of busbars) 20B.

The electric heating wire 20L for preventing fogging and frost is provided in the region including the light-transmitting portion TP located in front of the optical devices such as a camera and a radar included in the optical apparatus, thereby making it possible to improve the sensing accuracy of the optical apparatus.

The following can be designed as appropriate: the number of the electric heating wires 20L, the number of the connection wires 20M, the number of the feeding electrodes 20B; the line pattern and array pattern of the electric heating wires 20L and the connection wires 20M; the shape and arrangement pattern of the feeding electrodes 20B; and the like.

For example, it is preferable that the electric heating wire 20L be bent so as to cross the light-transmitting portion TP a plurality of times in a plan view, thereby making it possible to efficiently remove frost and water droplets adhering to the light-transmitting portion TP.

The line width of the electric heating wire 20L and/or each connection wire 20M may be substantially the same or may vary in the part from one feeding electrode to the other feeding electrode.

As shown in FIG. 7, in this embodiment, the conductor 20 is formed on the surface S4 of the glass plate with terminals 13X, the surface S4 being on the opposite side of the intermediate film 12 (the surface S4 being on the vehicle inner side).

Each of the pair of feeding electrodes (pair of busbars) 20B includes a terminal joint portion 20T, and the terminal joint portion 20T of the conductor 20 has a terminal 102 joined thereto with lead-free solder 101 interposed therebetween. The terminal 102 has a feeding member 103 fixed thereto, the feeding member 103 including a round-wire-shaped or foil-shaped conducting wire.

The terminal joint portion 20T of the conductor 20 is a portion immediately underneath the lead-free solder 101. In the figure, the region of the terminal joint portion 20T is a region sandwiched between two broken lines T1 and T2. Note that the position of the terminal joint portion 20T of the conductor 20 is not clearly determined from the beginning. The terminal joint portion 20T is the portion immediately underneath the lead-free solder 101 after the terminal 102 is joined to the feeding electrode 20B with the lead-free solder 101 interposed therebetween.

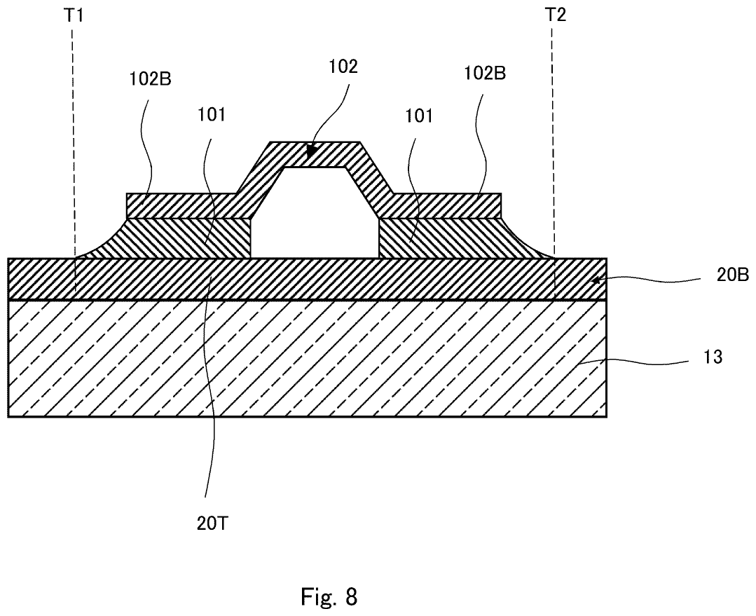

FIG. 8 is a partially enlarged cross-sectional view of the laminated structure of a terminal 102/lead-free solder 101/feeding electrode 20B/second glass plate 13, shown in FIG. 7, viewed from the left side of FIG. 7. Here, the laminated structure is turned upside down for easier visual recognition.

A feeding member 103 is preferably a round-wire-shaped or foil-shaped conducting wire, more preferably a round-wire-shaped or foil-shaped covered conducting wire. The covered conducting wire is preferably a wire harnesses, a flat harnesses, or the like.

The feeding member 103 has a head end portion having a conductor-exposed portion to which the terminal 102 is fixed.

As the terminal 102, a known crimp terminal is preferable. The crimp terminal preferably has: a feeding member joint portion 102A (see FIG. 7) in contact with the head end portion (conductor-exposed portion) of the feeding member 103; and a solder joint portion 102B in contact with the lead-free solder 101 (see FIGS. 7 and 8).

When a wire harness is used as a feeding member 103, the crimp terminal is preferably a crimp terminal including: a feeding member joint portion 102A, in a tubular shape etc., that caulks and fixes the head end portion (conductor-exposed portion) of the wire harness; and a bridge-shaped portion having solder joint portions 102B at opposing ends, as shown in FIGS. 7 and 8. The crimp terminal may be one that has one solder joint portion 102B without having a bridge-shaped portion.

As the terminals 102, terminals made of metal are preferable. The constituent metal of the terminals is not particularly limited, and examples thereof include: metals such as copper, iron, chromium, and zinc; alloys containing one or more metal elements such as copper, iron, chromium, and zinc; and combinations thereof. Examples of the alloy include brass. The surface of the terminals 102 may be subjected to a surface treatment such as tin plating. At least a part of a terminal 102 may be covered with an insulating material. The thickness of a terminal 102 is not particularly limited, and is preferably 0.4 to 0.8 mm. The terminals 102 made of a single material can be manufactured, for example, by punching a metal plate (pressing processing using a cutting die) to obtain metal plates of a desired size and then bending this (bending processing).

For example, a terminal 102 (preferably a crimp terminal) is caulked and fixed to the head end portion (conductor-exposed portion) of the feeding member 103, and the terminal 102 is joined to the terminal joint portion 20T in the feeding electrode 20B with lead-free solder 101 interposed therebetween. Note that the head end portion (conductor-exposed portion) of a feeding member 103 and the terminal 102 may be connected by soldering or welding.

As shown in FIG. 7, in the conductor 20 included in the glass plate with terminals 13X, at least the feeding portions (a pair of feeding electrodes 20B) are formed directly on the second glass plate 13. In other words, in the conductor 20 included in the glass plate with terminals 13X, at least the feeding portion (a pair of feeding electrodes 20B) is formed on the surface of the second glass plate 13, in contact with the second glass plate 13 without a light-shielding layer therebetween. In the conductor 20 included in the glass plate with terminals 13X, the feeding portion is not covered with the second light-shielding layer BL2 so that the terminals 102 can be joined on the feeding portion.

FIGS. 1A, 2 and 3, the reference signs NBL each denote a non-formation region of the second light-shielding layer BL2, the region including the region of the feeding portion.

In the above-described configuration, the feeding portion consisting of the pair of feeding electrodes 20B does not contain components of the glass frit derived from the material for forming the light-shielding layer. This can reduce the amount of components of the glass frit present on the surface of the feeding portion formed on the light-shielding layer. It is thought that this will make it possible to improve the wettability of the lead-free solder for the feeding portion, improve the joining strength of the lead-free solder for the feeding portion, and form well-shaped solder fillets. According to this embodiment, combination of the above effects allows increase in the breaking strength of the glass plate after terminal attachment.

As shown in FIGS. 5 to 7, in the glass plate with terminals 13X, it is preferable that the entire conductor 20 including the electric heating wire 20L, the connection wires 20M, and the feeding portion consisting of the pair of feeding electrodes 20B be formed directly on the second glass plate 13. In this configuration, the electric heating wire 20L, the connection wires 20M, and the feeding portion are formed on the same plane, so that breakage of the electric heating wire 20L and the connection wires 20M can be prevented.

In this embodiment, as shown in FIG. 7, the first light-shielding layer BL1 is formed on the surface S2 of the first glass plate 11, the first light-shielding layer BL1 covering, in a plan view, the feeding portion (the pair of feeding electrodes 20B) of the conductor 20 included in the glass plate with terminals 13X, the surface S2 being on the intermediate film 12 side (the surface S2 being on the vehicle inner side, the surface S2 facing the second glass plate 13).

In addition, the second light-shielding layer BL2 is formed on the surface S4 of the glass plate with terminals 13X, the second light-shielding layer BL2 covering at least a part of the conductor 20 except for the feeding portion in a plan view, the surface S4 being on the opposite side of the intermediate film 12 (the surface S4 being on the vehicle inner side).

With this configuration, at least a part of the conductor 20 included in the glass plate with terminals 13X, preferably most of the conductor 20 included in the glass plate with terminals 13X, can be designed so as not to be visible to people outside the vehicle.

The planar pattern of the first light-shielding layer BL1 just needs to be a pattern that covers the feeding portion (the pair of feeding electrodes 20B) of the conductor 20 included in the glass plate with terminals 13X in a plan view, and can be designed as appropriate.

As shown in FIG. 1B, the formation region of the first light-shielding layer BL1, like the second light-shielding layer BL2, can include the region of the optical apparatus mounting region OP excluding the light-transmitting portion TP, the region around the optical apparatus mounting region OP, and the peripheral region of the windshield for vehicle 1.

In the illustrated example, the formation region of the first light-shielding layer BL1 is, like the second light-shielding layer BL2, includes: the region of the optical apparatus mounting region OP excluding the light-transmitting portion TP; and the region around the optical apparatus mounting region OP, and includes: a region R11 of a substantially trapezoidal region, the outline of which is formed of one end side 10E of the laminated glass 10 (in the illustrated example, the upper end side) and sides B11 to B13, excluding the light-transmitting portion TP; and a peripheral region R12 of the windshield for vehicle 1. In the region R11, it is not necessary to partially provide the non-formation region of the first light-shielding layer BL1.

Note that the planar shape of the region R11 of the first light-shielding layer BL1 and the planar shape of the region R21 of the second light-shielding layer BL2 can be designed independently of each other, and the planar shapes of these regions may be the same or different. For example, the planar shape of the region R11 of the first light-shielding layer BL1 may be designed to be wider than the region R21 of the second light-shielding layer BL2.

Likewise, the planar shape of the region R12 of the first light-shielding layer BL1 and the planar shape of the region R22 of the second light-shielding layer BL2 can be designed independently of each other, and the planar shapes of these regions may be the same or different.

As shown in FIGS. 1A, 1i, 2 and 5, in this embodiment, the first light-shielding layer BL1 and the second light-shielding layer BL2 are not formed in the light-transmitting portion TP.

As shown in FIGS. 2 and 6, at least a part of the connection wires 20M is covered with a second light-shielding layer BL2.

As shown in FIG. 2, it is preferable that most part of the connection wires 20M, except for the vicinity of the feeding electrodes 20B, be covered with a second light-shielding layer BL2.

“The vicinity of the feeding electrodes” in the connection wires are each within a range of 4.0 mm from the feeding electrode, for example.

The non-formation regions NBL of the second light-shielding layer BL2 can be appropriately designed within ranges that satisfy the condition that the non-formation regions NBL include regions of the feeding portion (the pair of feeding electrodes 20B). As shown in FIG. 2, it is preferable to design the non-formation regions NBL of the second light-shielding layer BL2 so that the non-formation regions NBL include the regions of the feeding portion (the pair of feeding electrodes 20B) and most part of the connection wires 20M except for the vicinity of the feeding electrodes 20B is covered by the second light-shielding layer BL2.

In the conductor 20, the electric heating wire 20L is designed to be thin so as to be unlikely to be visible to people outside the vehicle and so as not to affect the acquisition of information about the area in front of the vehicle by an optical apparatus through the light-transmitting portion TP.

The feeding portion (the pair of feeding electrodes 20B) is covered with the first light-shielding layer BL1 in a plan view, and is therefore not visible to people outside the vehicle.

Although details will be described later, the feeding portion (the pair of feeding electrodes 20B) can be placed inside or outside the optical apparatus mounting region OP.

At least a part, preferably most part of, the connection wires 20M is covered with the second light-shielding layer BL2 in a plan view.

The connection wires 20M can be designed so that at least its part, preferably its most part, more preferably its entirety is covered with the first light-shielding layer BL1 in a plan view, and is not visible to people outside the vehicle.

Typically, in conventional technique, there is no light-shielding layer within the light-transmitting portion, and the electric heating wire formed inside the light-transmitting portion is not formed on the light-shielding layer, whereas the connection wires and feeding portion formed outside the light-transmitting portion are formed on the light-shielding layer. In such a configuration, steps are created between the ends of the electric heating wire in the light-transmitting portion and the ends of the connection wires connected thereto, the steps each having a height equal to the thickness of the light-shielding layer (for example, 5 to 20 μm). In this conventional technique, the line width of the electric heating wire in the light-transmitting portion is designed to be thin so as to be unlikely to be visible and so as not to affect the acquisition of information about the area in front of the vehicle by the optical apparatus through the light-transmitting portion TP, while the line width of each connection wire is designed to be thicker than the line width of the electric heating wire in the light-transmitting portion to prevent breakage at the step portions.

In this embodiment, the electric heating wire 20L formed inside the light-transmitting portion TP, and the connection wires 20M and the feeding portion formed outside the light-transmitting portion TP can be formed directly on the second glass plate 13. In this configuration, steps corresponding to the thickness of the light-shielding layer are not created between the ends of the electric heating wire 20L in the light-transmitting portion TP and the ends of connection wires 20M connected thereto. As in the conventional case, the line width of the electric heating wire 20L in the light-transmitting portion TP is designed to be thin so as to be unlikely to be visible and so as not to affect the acquisition of information about the area in front of the vehicle by an optical apparatus through the light-transmitting portion TP. In order to prevent breakage due to the step, the line width of each connection wire 20M does not need to be designed to be thicker than the line width of the electric heating wire 20L in the light-transmitting portion TP, and the line width thereof can be substantially the same as the line width of the electric heating wire 20L in the light-transmitting portion TP. In this embodiment, for example, the line width of the electric heating wire 20L and the connection wire 20M can be designed to be 0.1 to 1.0 mm. The line width of the electric heating wire 20L and the connection wire 20M is preferably 0.1 to 0.7 mm, and more preferably 0.1 to 0.4 mm.

In this description, unless otherwise specified, “the line width of the electric heating wire and the line width of each connection wire are substantially the same” is defined as follows: the maximum and minimum values of the line width of the connection wire is within a range from the maximum value to the minimum value of the line width of the electric heating wire.

The line width of the electric heating wire and the connection wire can be measured using a loupe, a microscope, a surface roughness meter, or the like.

If the line width of each connection wire 20M is made thinner than the conventional, the electrical resistance increases, but it is possible to design the length of the connection wire 20M to be shorter than the conventional.

If the line width of each connection wire 20M is 0.1 to 1.0 mm, or if the line width of the connection wire 20M is substantially the same as the line width of the electric heating wire 20L, the connection wire 20M is unlikely to be visible to people outside the vehicle, like the electric heating wire 20L. In this case, even if a part of the connection wires 20M is not covered by the first light-shielding layer BL1 or the second light-shielding layer BL2 in a plan view, there is no problem in terms of appearance.

The housing of the optical apparatus can be attached to the glass plate with terminals 13X using one or more materials including an adhesive, preferably a combination of an adhesive and a double-sided tape.

Examples of the adhesive include epoxy adhesives, urethane adhesives, silicone adhesives, modified silicone adhesives, melamine adhesives, phenol adhesives, acrylic adhesives, and combinations of these. The adhesive may be of one-component or two-component. Specific examples of adhesives include modified silicone/epoxy adhesives, two-component urethane adhesives, one-component thermosetting urethane adhesives, and second generation acrylic adhesives (SGA). Of these, urethane adhesives are preferred from the viewpoints of the stability of adhesion to the housing of the optical apparatus, flexibility, and the like.

In the conventional technique in which the connection wire and the feeding portion are formed on the light-shielding layer, the housing of the optical apparatus is bonded at a position outside the conductor for the optical apparatus with a sufficient gap from the conductor. In this case, it is necessary to design the shape and size of the housing so as to take a sufficient gap from the conductor for the optical apparatus at a position outside the conductor, making it difficult to reduce the size of the housing.

In this embodiment, in the glass plate with terminals 13X on which the optical apparatus is attached, the feeding portion is not covered by the second light-shielding layer BL2 formed on the glass plate with terminals 13X, and at least a part of the connection wires 20M is covered by the second light-shielding layer BL2 formed on the glass plate with terminals 13X. In the connection wires 20M, the conductor is not exposed in the part covered with the second light-shielding layer BL2, so that ion migration does not occur between the conductor and the adhesive. Therefore, the housing of the optical apparatus can be fixed even to a region where the connection wires 20M are present if the region is where the connection wires 20M are covered with the second light-shielding layer BL2. In this case, the housing of the optical apparatus can be fixed onto the second light-shielding layer BL2 around the light-transmitting portion TP with one or more materials including an adhesive interposed therebetween. In other words, in this embodiment, the glass plate with terminals 13X, on which the optical apparatus is attached, has the adhesive region of the housing of the optical apparatus including at least a part of the formation region of the connection wires 20M, the adhesive region being able to be covered with the second light-shielding layer BL2.

In this embodiment, the shape and size of the housing can be freely designed if the housing avoids the regions of the light-transmitting portion TP and the feeding portion, allowing the housing to be also made compact. Since the surface of a silver-containing conductor is likely to be damaged in general, the surface of the connection wires 20M may be damaged and broken when the housing of the optical apparatus is attached, for example. Covering at least a part of the connection wires 20M with the second light-shielding layer BL2 allows the connection wires 20M to be prevented from being damaged in attaching the housing of the optical apparatus or the like.

In this embodiment, for example, in the glass plate with terminals 13X, the outer periphery of the optical apparatus mounting region OP can be designed to pass, in a plan view, between the light-transmitting portion TP and the feeding portion consisting of the pair of feeding electrodes 20B. FIG. 3 shows a design example OP1 of the optical apparatus mounting region OP in this case. If the optical apparatus mounting region OP avoids the light-transmitting portion TP and the feeding portion consisting of the pair of feeding electrodes 20B, the optical apparatus mounting region OP can be designed to be smaller than the design example OP1 shown in FIG. 3.

FIG. 4 shows OP1 and OP2 as design examples of the optical apparatus mounting region OP. The design example OP1 in FIG. 4 is the same as the design example OP1 shown in FIG. 3. The design example OP2 is a design example of a conventional optical apparatus mounting region OP, and is an example in which the shape and size of the housing are designed so as to make a gap with the conductor for the optical apparatus at a position outside the conductor. FIG. 4 shows how, in this embodiment, optical apparatus mounting region OP can be designed to be smaller than the conventional.

In the conventional technique in which the connection wire and the feeding portion are formed on the light-shielding layer, from the viewpoint of preventing ion migration between the silver-containing conductor and the adhesive, the separation distance between the housing of the optical apparatus and the conductor in a plan view is preferably more than 6 mm.

In contrast, in this embodiment, the separation distance between the housing of the optical apparatus and the conductor 20 in a plan view is not particularly limited, and may be 20 mm or less, 14 mm or less, or 10 mm or less. The housing of the optical apparatus and the conductor 20 may overlap in a plan view.

In this embodiment, if there is no need to make the housing compact, the shape and size of the housing may be designed, as in the conventional case, so as to make a gap with the conductor for the optical apparatus at a position outside the conductor. Any of the design examples OP1 and OP2 shown in FIG. 4 can be employed in this embodiment. In this embodiment, the degree of freedom in designing the optical apparatus mounting region OP is higher than the conventional.

### (Manufacturing Method)

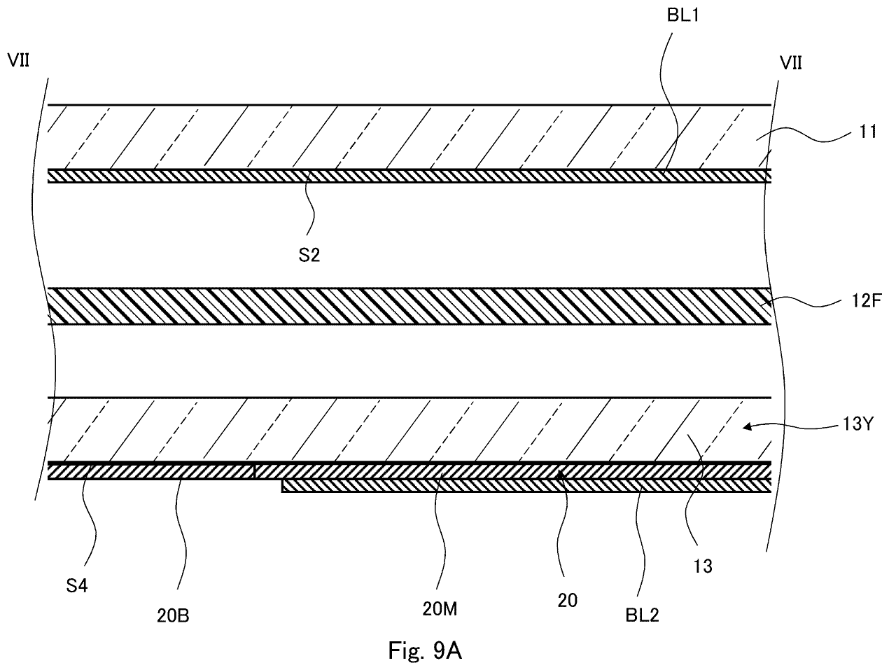

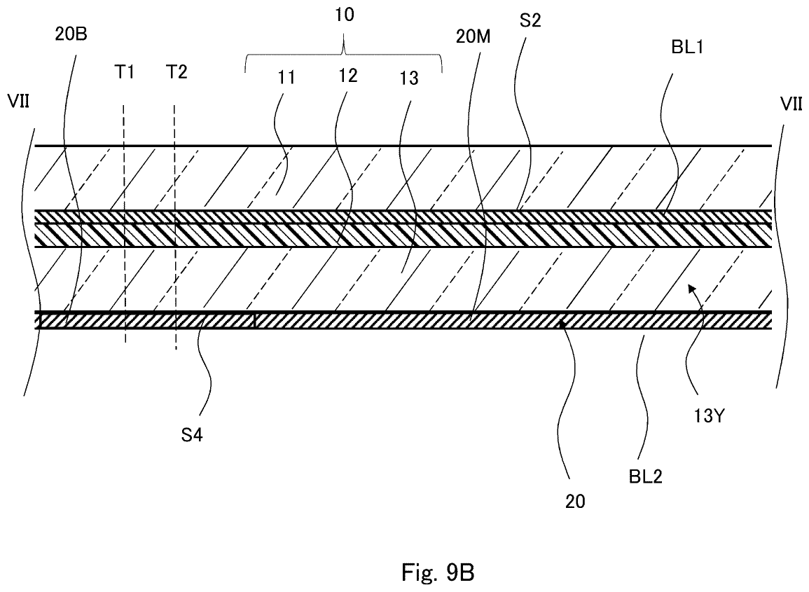

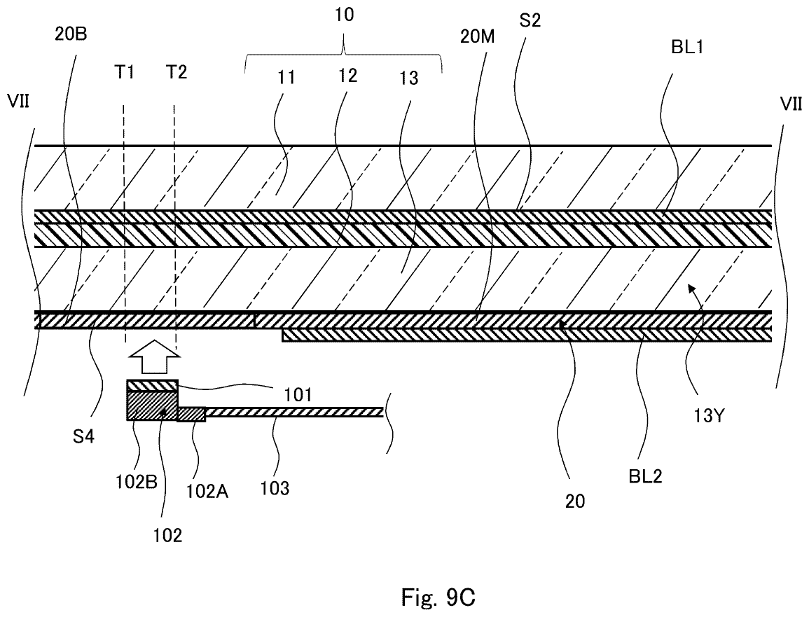

Each step of a method for manufacturing the windshield for vehicle according to this embodiment will be described with reference to the drawings. FIGS. 9A to 9C are schematic cross-sectional views corresponding to FIG. 7.

### (Step (S1))

First, a silver-containing paste containing silver powder and glass frit is applied directly onto the surface S4 of the second glass plate 13 and dried to form a silver-containing paste layer. The drying conditions can be appropriately designed depending on the paste composition, and are preferably, for example, 120 to 150° C. for about 5 minutes.

### (Step (S2))

Next, a ceramic paste containing a black pigment and glass frit is applied as a light-shielding layer material onto the surface S2 of the first glass plate 11 and onto the second glass plate 13 on which the silver-containing paste layer has been formed, and then dried to form a ceramic paste layer. The drying conditions can be appropriately designed depending on the paste composition, and are preferably, for example, 120 to 150° C. for about 5 minutes.

### (Step (S3))

Next, each glass plate is heated to a temperature of the softening point or above, and is bent. In this step, the silver-containing paste layer and the ceramic paste layer are simultaneously fired to form the conductor 20, the first light-shielding layer BL1, and the second light-shielding layer BL2. After firing, each glass plate is slowly cooled.

After these steps, as shown in FIG. 9A, there are obtained: the first glass plate 11 having the first light-shielding layer BL1; and a glass plate with a conductor 13Y having a conductor 20 and the second light-shielding layer BL2 on one surface of the second glass plate 13.

Next, as shown in FIG. 9A, the first glass plate 11 having the first light-shielding layer BL1 and the glass plate with the conductor 13Y are bonded together with a resin film 12F interposed therebetween by a known method, the resin film being the material of the intermediate film 12.

The constituent resin of the resin film 12F is not particularly limited, and is preferably one or more types of resin selected from the group consisting of polyvinyl butyral (PVB), ethylene vinyl acetate copolymer (EVA), cycloolefin polymer (COP), polyurethane (PU), and ionomer resin, for example. The resin film 12F may contain one or more types of additives other than resin, as necessary. Examples of additives include colorants such as pigments. The resin film 12F may be colorless and transparent, or colored and transparent. The resin film 12F may have a single layer structure or a laminated structure of two or more layers.

The bonding can be implemented by thermocompression bonding. Examples of the thermocompression bonding method include: a method of placing a temporary laminate obtained by stacking a plurality of members shown in FIG. 9A in a bag made of rubber or the like and heating it in a vacuum; a method of pressurizing and heating the temporary laminate using an automatic pressurizing and heating treatment apparatus, an autoclave, etc.; and combinations thereof.

The thermocompression bonding conditions of temperature, pressure, and time are not particularly limited, and are designed depending on the type and temperature of the resin film 12F. The thermocompression bonding conditions may be any conditions under which the resin film 12F is softened, sufficient pressure is applied, and the first glass plate 11 and the glass plate with the conductor 13Y are sufficiently bonded together with the resin interposed therebetween. Thermocompression bonding may be implemented in a plurality of stages in different methods or conditions.

The constituent resin of the resin film 12F softens and spreads so as to fill the space between the first glass plate 11 and the glass plate with the conductor 13Y.

After these steps, a laminated glass 10 shown in FIG. 9B is obtained.

### (Step (S4))

Next, as shown in FIG. 9C, the terminals 102 are joined onto the terminal joint portions 20T included in the feeding electrodes 20B with the lead-free solder 101 interposed therebetween. To the terminals 102, feeding members 103 each preferably including a round-wire-shaped or foil-shaped conducting wire are fixed (preferably fixed by caulking) in advance by a known method. For the solder jointing, see also FIG. 8.

Solder joining can be implemented by a known method, preferably a method using a soldering iron or resistance heating.

In using a soldering iron, for example, joining can be implemented as follows.

An appropriate amount (for example, 0.05 to 0.10 g) of lead-free solder is attached to each solder joint portion of the terminal. The terminal is placed on the terminal joint portion of the conductor. In this state, the tip of a soldering iron set at a temperature of the melting point of the lead-free solder or above is pressed against the solder joint portion of the terminal to heat and melt the lead-free solder. Thereafter, the soldering iron is removed from the terminal, and the lead-free solder is solidified by natural cooling.

Before soldering, it is preferable to apply flux to the surface of the unmelted lead-free solder and/or the surface of the solder joint portion of the terminal. The metal oxide film is melted by the action of the flux, and a sufficient joining state can be obtained.

Before solder joining, it is preferable to place an appropriate amount of lead-free solder on the tip of a soldering iron, and heat and melt it. This solder is called preliminary solder and can improve heat conduction in solder joining.

Generally, in order to join a conductor and solder sufficiently, it is necessary to form an alloy layer containing an alloy of one or more metal elements contained in the conductor and a plurality of metal elements contained in the solder at the joining interface between the conductor and the solder. Therefore, solder joining is implemented by heating the solder to its melting point or above.

The melting point of lead-free solder such as SnAg-based and SnAgCu-based solder is, for example, about 220° C., and in this case, the solder joining temperature is preferably, for example, about 300° C.

In the manner described above, the windshield for vehicle 1 of this embodiment is manufactured.

As described above, according to the present disclosure, it is possible to provide a windshield for vehicle that includes a portion in which a conductor and a terminal are joined using lead-free solder, can be designed so that the feeding portion of the conductor is not visible to people outside the vehicle, and can increase the breaking strength of the glass plate after terminal attachment.

According to the present disclosure, it is also possible to provide a windshield for vehicle with an optical apparatus. The windshield for vehicle has an optical apparatus mounting region, includes a portion in which a conductor and a terminal are joined using lead-free solder, can be designed so that the feeding portion of the conductor is not visible to people outside the vehicle, can increase the breaking strength of the glass plate after terminal attachment, and allows the housing of the optical device to be made compact.

### EXAMPLES

The present invention will be described below based on Examples, but the present invention is not limited thereto. In each of the combinations of the ceramic paste and the silver-containing paste in Examples 1 to 6, glass plates for evaluation 1 and 2 are examples, and a glass plate for evaluation 3 is a comparative example.

### [Evaluation Items and Evaluation Methods]

The evaluation items and evaluation methods are as follows.

### (Breaking Strength)

A ring bending test was conducted in accordance with ASTM-C1499-1 using an Autograph (“AGS-X” manufactured by Shimadzu Corporation, maximum load: 5 kN) in an environment at normal temperature (20 to 25° C.).

The glass plate for evaluation 1, 2 or 3 was placed on a support ring having a diameter of 98 mm with the surface on which the conductor was formed facing downward. A load ring with a diameter of 46 mm was placed on this glass plate for evaluation. The central axis of the support ring, the central axis of the glass plate, and the central axis of the load ring were aligned.

A load was applied around the conductor of the glass plate for evaluation using a load ring. The load was continuously increased so that the amount of displacement of the glass plate was 1 mm/min, and the load at which the glass plate broke was defined as the breaking strength.

A total of five samples were measured for each condition, and the average value was defined as data of the breaking strength.

### [Method for Manufacturing Glass Plate for Evaluation 1 (Laminate Structure: Conductor/Glass Plate)]

The glass plate for evaluation 1 having a laminated structure of conductor/glass plate was manufactured in the same manner as in the [Method for Manufacturing Glass Plate for Evaluation 3] described later, except that only the conductor was formed on one surface of the glass plate.

### [Method for Manufacturing Glass Plate for Evaluation 2 (Laminate Structure: Light-Shielding Layer/Conductor/Glass Plate)]

The glass plate for evaluation 2 having a laminated structure of light-shielding layer/conductor/glass plate was manufactured in the same manner as in the [Method for Manufacturing Glass Plate for Evaluation 3] described later, except that the order of forming the ceramic paste layer and the conductive paste layer was reversed.

### [Method for Manufacturing Glass Plate for Evaluation 3 (Laminate Structure: Conductor/Light-Shielding Layer/Glass Plate)]

A 100 mm×100 mm square, 3.5 mm thick, un-tempered glass plate (“VFL” manufactured by AGC, green) was prepared. A ceramic paste for forming a light-shielding layer containing a black pigment and glass frit was applied onto one surface of this glass plate by a screen printing method, and dried to form a ceramic paste layer. The drying conditions were 120° C. for 15 minutes.

Next, a silver-containing paste for forming a conductor containing silver powder and glass frit was applied onto the ceramic paste layer by a screen printing method, and dried to form a conductive paste layer. The drying conditions were 120° C. for 10 minutes.

Next, the ceramic paste layer and the conductive paste layer were fired. The temperature was raised from normal temperature (20 to 25° C.) to 600° C. at a heating rate of about 180° C./min, fired at 600° C. for 400 seconds, and then naturally cooled to normal temperature (20 to 25° C.). In this way, a light-shielding layer and a conductor were formed.

The planar shape of the light-shielding layer was a square of 90 mm×90 mm, and its center and diagonal were aligned with the center and diagonal of the glass plate. The thickness of the light-shielding layer was about 15 μm.

The planar shape of the conductor was a square of 30 mm×30 mm, and its center and diagonal were aligned with the center and diagonal of the glass plate. The thickness of the conductor was about 7 μm.

In this manner, the glass plate for evaluation 3 having a laminated structure of conductor/light-shielding layer/glass plate was manufactured.

### Examples 1-6

The combination of the ceramic paste and the silver-containing paste was changed, and with each combination, the glass plates for evaluation 1 to 3 were manufactured and evaluated.

Two types of commercially available ceramic pastes were prepared. The abbreviations for the two types of ceramic pastes were BCP1 and BCP2.

Three types of commercially available silver-containing pastes were prepared. The three types of silver-containing pastes were abbreviated as AgP1, AgP2, and AgP3.

### [Evaluation Results]

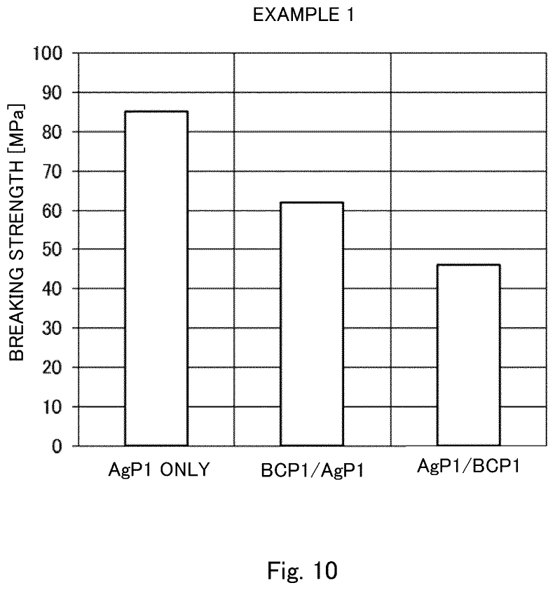

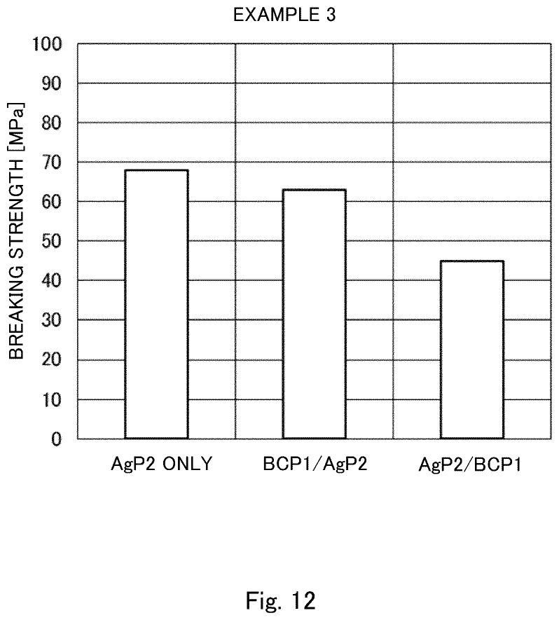

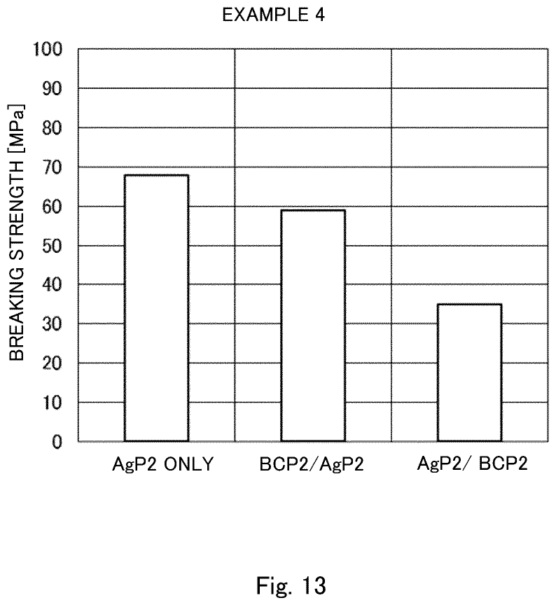

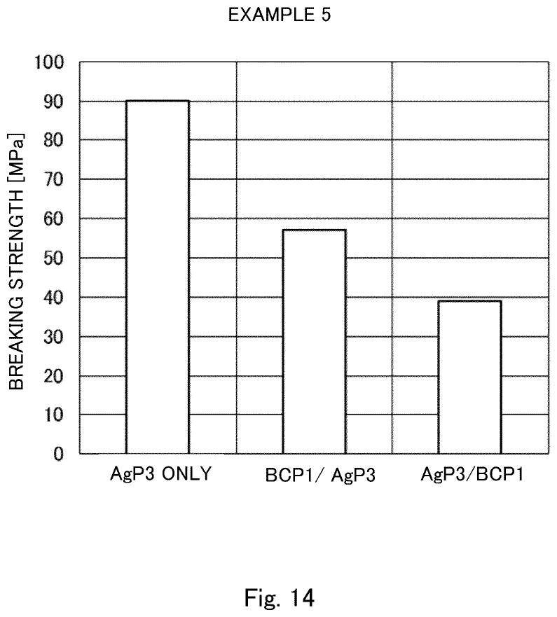

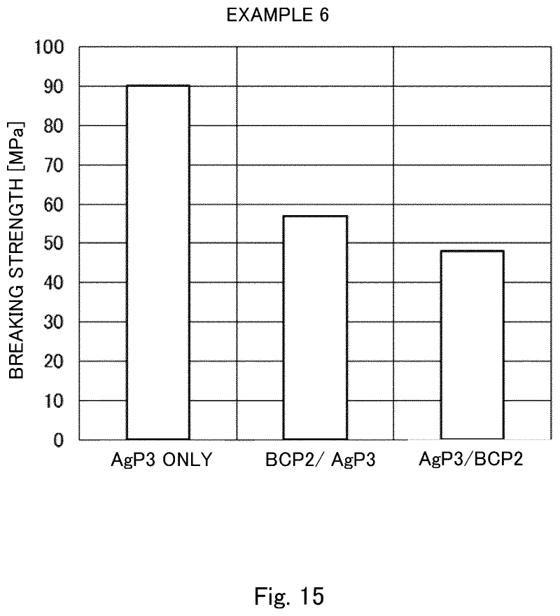

The evaluation results are shown in FIGS. 10 to 15, and Tables 1 and 2.

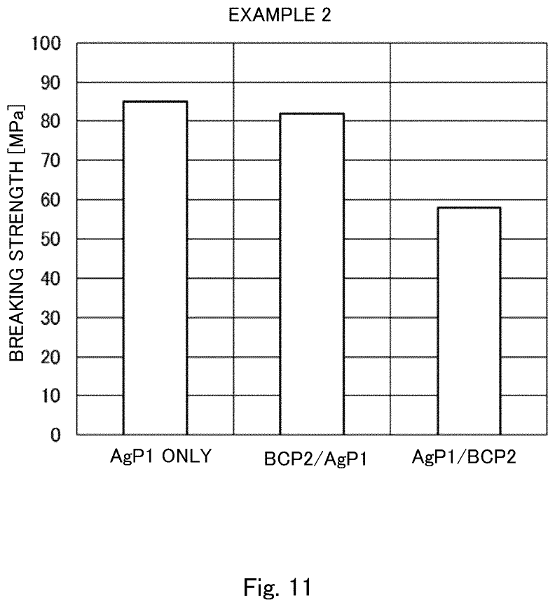

In FIG. 10, the data for “AgP1 only” shows the evaluation results for glass plate for evaluation 1 obtained using only the silver-containing paste AgP1, the data for “BCP1/AgP1” shows the evaluation results for glass plate for evaluation 2 obtained by laminating ceramic paste BCP1 on silver-containing paste AgP1 and firing, and the data for “AgP1/BCP1” shows the evaluation results for glass plate for evaluation 3 obtained by laminating silver-containing paste AgP1 on ceramic paste BCP1 and firing. The same applies to FIGS. 11 to 15.

In all the examples, the breaking strength decreased in the order of the glass plate for evaluation 1, the glass plate for evaluation 2, and the glass plate for evaluation 3. In all the examples, the breaking strength of the glass plate for evaluation 1 was the highest.

It has been found that the breaking strength of the feeding portion to which the terminal is joined can be increased by forming a conductor directly on the glass plate without forming a light-shielding layer to configure the conductor without covering it with a light-shielding layer. Note that in Examples 1 to 6, no terminal joining was performed, but when the conductor is a feeding portion, the breaking strength after terminal attachment increases as the breaking strength before terminal attachment increases.

It has been found that it is preferable to employ a laminated structure of the glass plate for evaluation 1 or 2 for a portion of the conductor, other than the feeding portion, which does not undergo terminal joining. In addition, the portion of the conductor, other than the feeding portion, which does not undergo terminal joining, is not subjected to high temperatures when a terminal is joined. Therefore, it is acceptable for the portion other than the feeding portion to have a lower breaking strength than the feeding portion.

TABLE 1

| | | Breaking strength (MPa) | | |
|---|---|---|---|---|
| | | Material of light-shielding layer | | |
| | | | BCP1 | |
| | | — | Glass plate for evaluation 2 | Glass plate for evaluation 3 |
| | Material of | Glass plate for evaluation 1 | Light-shielding layer/ | Conductor/light-shielding |
| Example | conductor | Conductor/glass plate | conductor/glass plate | layer/glass plate |
| Example 1 | AgP1 | 84 | 62 | 46 |
| Example 3 | AgP2 | 68 | 63 | 45 |
| Example 5 | AgP3 | 90 | 57 | 39 |

TABLE 2

| | | Breaking strength (Mpa) | | |
|---|---|---|---|---|
| | | Material of light-shielding layer | | |
| | | | BCP2 | |
| | | — | Glass plate for evaluation 2 | Glass plate for evaluation 3 |
| | Material of | Glass plate for evaluation 1 | Light-shielding layer/ | Conductor/light-shielding |
| Example | conductor | Conductor/glass plate | conductor/glass plate | layer/glass plate |
| Example 2 | AgP1 | 84 | 82 | 58 |
| Example 4 | AgP2 | 68 | 59 | 35 |
| Example 6 | AgP3 | 90 | 57 | 48 |

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A windshield for vehicle comprising a laminated glass in which a first glass plate and a second glass plate are bonded together with an intermediate film interposed therebetween,
the laminated glass including a glass plate with a terminal, the glass plate with the terminal including the second glass plate, a conductor, and the terminal, the conductor being formed on a surface of the second glass plate, the surface being on an opposite side of the intermediate film, the conductor including a material containing silver and glass frit, the conductor having a terminal joint portion to which the terminal is joined, the terminal being joined onto the terminal joint portion of the conductor with lead-free solder interposed therebetween, wherein
the conductor includes an electric function portion or is electrically connected to an electric function portion,
the conductor includes a feeding portion for feeding electricity to the electric function portion, and the feeding portion includes the terminal joint portion,
in the conductor, at least the feeding portion is formed directly on the second glass plate,
a first light-shielding layer is formed on a surface of the first glass plate, the first light-shielding layer covering the feeding portion of the conductor in a plan view, the surface being on a side of the intermediate film, and
a second light-shielding layer is formed on a surface of the glass plate with the terminal, the second light-shielding layer covering at least a part of the conductor except for the feeding portion in a plan view, the surface being on an opposite side of the intermediate film.

2. The windshield for vehicle according to claim 1, wherein
in a plan view, the glass plate with the terminal includes: an optical apparatus mounting region where an optical apparatus is mounted; and a light-transmitting portion, located within the optical apparatus mounting region, through which light incident on the optical apparatus from an outside and/or light emitted from the optical apparatus passes,
the second light-shielding layer is formed so as to surround at least a part of the light-transmitting portion in a plan view, and
the conductor includes an electric heating wire formed inside the light-transmitting portion, the feeding portion formed outside the light-transmitting portion, and a connection wire formed outside the light-transmitting portion and connecting the electric heating wire and the feeding portion.

3. The windshield for vehicle according to claim 2, wherein
in the glass plate with the terminal, the electric heating wire, the connection wire, and the feeding portion are formed directly on the second glass plate, and
in a plan view, the feeding portion is not covered by the second light-shielding layer, and at least a part of the connection wire is covered by the second light-shielding layer.

4. The windshield for vehicle according to claim 2, wherein the electric heating wire and the connection wire each have a line width of 0.1 to 1.0 mm.

5. The windshield for vehicle according to claim 2, wherein a line width of the electric heating wire and a line width of the connection wire are substantially the same.

6. The windshield for vehicle according to claim 2, wherein in the glass plate with the terminal, an outer periphery of the optical apparatus mounting region passes between the light-transmitting portion and the feeding portion in a plan view.

7. The windshield for vehicle according to claim 2, wherein
the optical apparatus includes an optical device and a housing that houses the optical device, and
the housing of the optical apparatus is fixed on the second light-shielding layer.

8. The windshield for vehicle according to claim 7, wherein the housing of the optical apparatus is fixed onto the second light-shielding layer with one or more materials including an adhesive interposed therebetween.

9. The windshield for vehicle according to claim 8, wherein the adhesive is at least one adhesive selected from a group consisting of an epoxy adhesive, a urethane adhesive, a silicone adhesive, a modified silicone adhesive, a melamine adhesive, a phenol adhesive, and an acrylic adhesive.

10. The windshield for vehicle according to claim 2, wherein the second light-shielding layer contains a black pigment and glass frit.

11. The windshield for vehicle according to claim 1, wherein a feeding member including a round-wire-shaped or foil-shaped conducting wire is fixed to the terminal.
